(19) United States
(12) Patent Application Publication
(10) Pub. No.: US 2004/0236252 A1
(43) Pub. Date: Nov. 25, 2004

(54) Apparatus for treating cellulitis by combined methods

(76) Inventors: Francesco Muzzi, Firenze (IT); Leonardo Masotti, Firenze (IT)

Correspondence Address: MCGLEW & TUTTLE, PC, 1 SCARBOROUGH STATION PLAZA, SCARBOROUGH, NY, 10510-0827, US

(21) Appl. No.: 10/483,901

(22) PCT Filed: Jul. 9, 2002
(86) PCT No.: PCT/IT02/00452

(30) Foreign Application Priority Data
Jul. 13, 2001 (IT) FI2001A000133

(51) Int. Cl. A61H 1/02

(52) U.S. Cl. 601/1

(57) ABSTRACT

For the wide-ranging treatment of pathologies of the edematous fibroscleotic panniculopathy (EFP) type, such as cellulitis, a single apparatus, designed to make contact with the skin, comprises means for providing mechanical massage, means for extracting heat from the skin, and laser systems for biostimulation.

The inaccurate term “cellulitis” is applied to changes in the subcutaneous panniculus adiposus, predominantly cosmetic in nature, considered to occur mainly (but not exclusively) in females, and most commonly located in the trochanteric and upper lateral areas of the thighs. The term is inaccurate in that, in medicine, the suffix “itis” indicates an inflammatory process (as in tonsillitis, meaning inflammation of the tonsils, otitis, meaning inflammation of the ear, etc.), while in this case we are concerned with alterations and degenerative processes in the various layers of the skin and of the anatomic structures contained therein; care should be taken not to confuse “cellulitis” in its common interpretation with “pyogenic cellulitis” which is actually a bacterially induced inflammation of the interstitial and perivisceral cellular connective tissues. The medical term currently used in the literature as the most suitable definition of this pathology is “edematous fibrosclerotic panniculopathy” (EFP).

Cellulitis is caused by a number of genetic, constitutional, hormonal and vascular factors, frequently aggravated by sedentary lifestyle, stress, liver disease, poor nutrition, intestinal disorders or pathologies characterized by acute fluid retention.

Hormonal imbalances are the basic cause of cellulitis; because of the action of estrogen and its effects on the microcirculation, the female sex is predisposed to the development of this condition, especially in puberty, pregnancy or premenopause, in other words when the activity of the ovarian hormones is at a maximum level. Various factors, such as unsuitable clothing or footwear, postural disorders and incorrect bearing of the body, can predispose patients to the development of cellulitis by slowing the circulation of the blood and lymph.

There cannot be a single treatment for EFP, since the treatment varies according to the stage identified, and moreover, in the case of a complication of venous and lymphatic stasis, the treatment must be primarily directed toward the cure of the stasis itself. On the one hand, it is necessary to check or reduce a particular stage, while on the other hand it is necessary to cure the underlying disease; otherwise, possibly within a short time, we would find ourselves back at the starting point, or even in a worse situation.

A single form of treatment is not sufficient; there are various forms of treatment, some more effective than others, but each of them should be undertaken only when the current stage of the disease has been identified. Furthermore, a single form of treatment is not even sufficient for a single stage, since the forms of treatment must be integrated with each other, especially if venous and lymphatic stasis is to be reduced.

Many treatment methods are currently in widespread use, but none of these, taken by itself, provides a complete cure for panniculopathy.

Conventional methods are:

Mesotherapy;

Ozone therapy;

Electrolipolysis;

Ultrasound;

Pressure treatment;

Lymph drainage;

Passive gymnastics;

Massotherapy;

Drug treatment;

Laser treatment;

Carbon dioxide treatment.

The object of the invention is to facilitate the treatments and permit a wide range of interventions to achieve significant and sufficiently rapid results.

These and other objects will be made clear by the following text.

Essentially, the apparatus in question, designed for the wide-ranging treatment of pathologies of the edematous fibrosclerotic panniculopathy (EFP) type, commonly called cellulitis, is such that a single apparatus, designed to make contact with the skin, comprises means for providing mechanical massage, means for extracting heat from the skin, and laser systems for biostimulation.

In practice, it is possible to provide a handpiece whose surface for contact with the skin comprises an area for mechanical massage using a pulsating suction device, an area for the extraction of heat, and an area comprising laser diodes.

The area for skin massage can preferably be positioned in the center of said surface and can be surrounded by an annular cooled area for the extraction of heat and by an annular area comprising laser diodes. The annular cooled area for the extraction of heat can, in practice, comprise a channel for the circulation of a coolant fluid.

The annular area comprising laser diodes can be outside the annular cooled area for the extraction of heat and comprises a plurality of laser diodes spaced apart from each other at essentially equal intervals.

The invention will be more clearly understood from the description and the attached drawing, which shows a practical and non-restrictive example of the invention. In the drawing,

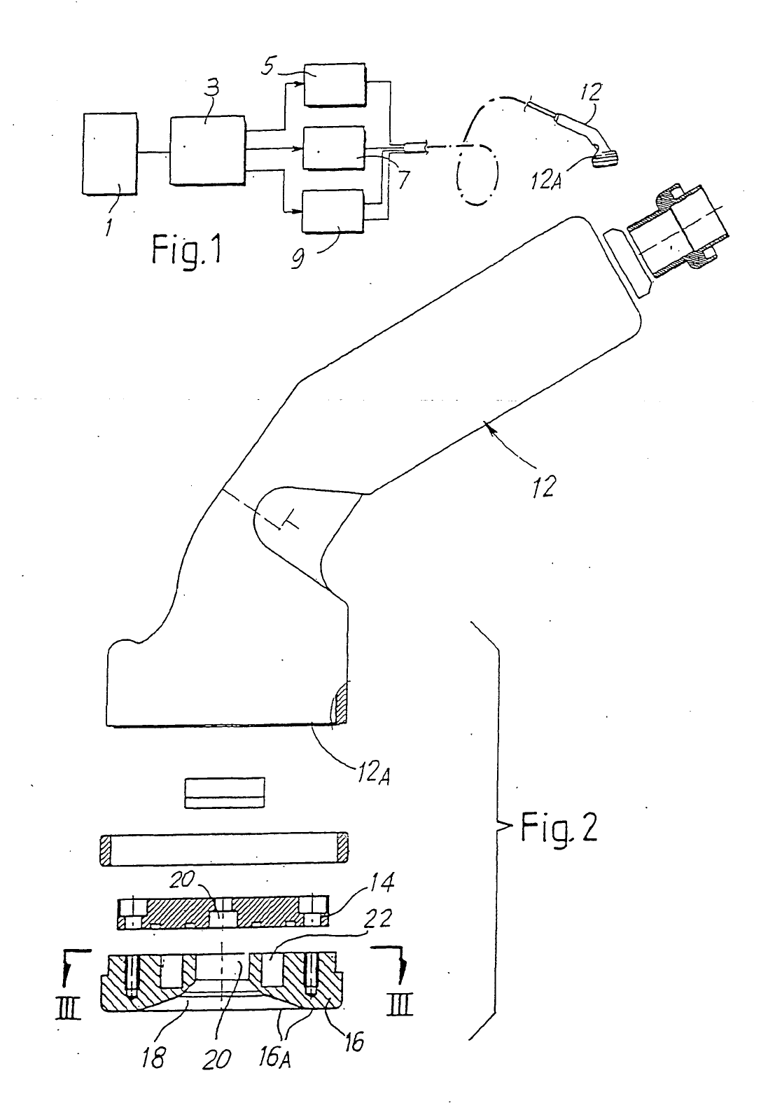

FIG. 1 shows a block diagram of the apparatus with the system connected to the application handpiece;

FIG. 2 shows an exploded view of the handpiece, with details in cross section;

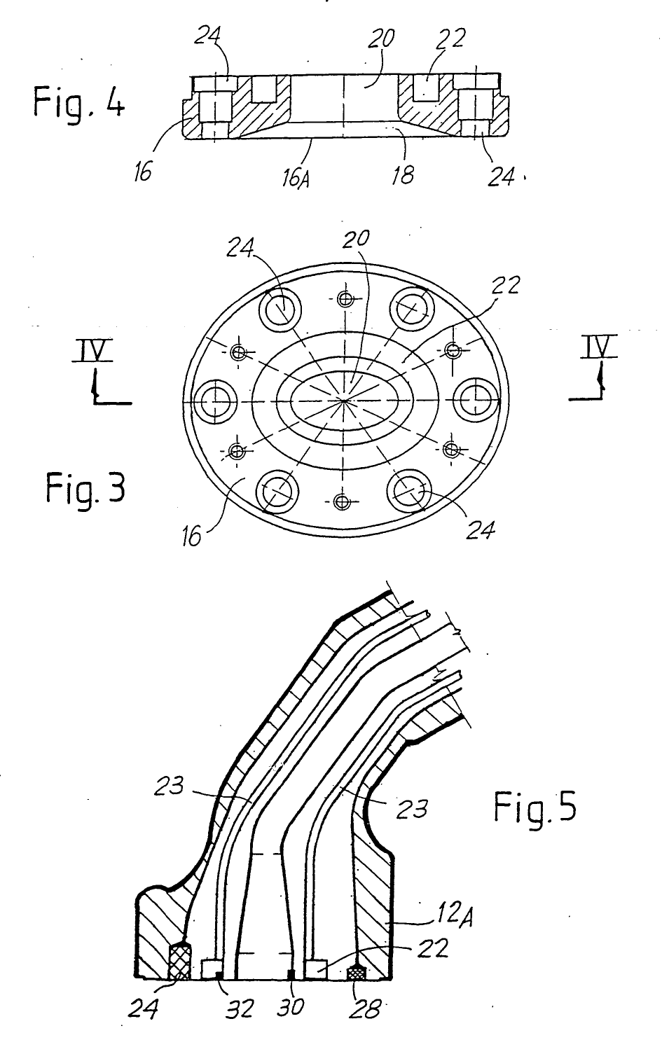

FIGS. 3 and 4 show a view through III-III in FIG. 2 and a view through IV-IV in FIG. 3; and

FIG. 5 shows in a highly schematic way the circuits and the components, including the sensors, which are associated with the active part of the handpiece designed to be pressed on the epidermis.

In the diagram in FIG. 1, the number 1 indicates a control panel associated with the apparatus, and the number 3 indicates the electronic control system, to which the active components of the equipment are connected; in particular, the number 5 indicates the pulsed suction system, the number 7 indicates the laser diode power supply system, and the number 9 indicates the cooling system. Each of these systems has a connection to the handpiece, which is indicated in a general way by 12 and described in greater detail below, to execute in combination the various functions that the apparatus can be used to provide.

The flared terminal part 12A of the handpiece, which is designed for application to the skin, is completed with two members, namely an intermediate member 14 and a terminal member 16, the latter having its exposed surface 16A shaped with a recess 18 connected to a passage 20 for connection to the pulsed suction device 5 through a flexible line and tie grip of the handpiece. A channel 22, with an essentially elliptical extension, is provided around the passage 20 in the member 16, and is connected to the cooling system 9 for the circulation—by means of lines 23—of a coolant fluid for absorbing heat from the epidermis to which the surface 16A of the member 16 is applied. Around the channel 22, which is delimited in the assembly by the intermediate member 14, open-ended housings 24 are formed in the member 16 to receive laser diodes which are distributed uniformly around the channel 22, there being six of these diodes, as in the example, or a different number, according to the structure of the apparatus and of the handpiece in particular. These laser diodes are connected to the power supply indicated in a general way by 7 in the block diagram of FIG. 1.

The assembly described above is completed, as shown in the diagram in FIG. 5, with suitable sensors, such as a sensor 28 for monitoring the contact with the patient's skin, a sensor 30 for monitoring the pressure drop, or a sensor 32 for monitoring the temperature. The number and positions of these sensors are such that the desired monitoring is achieved, and the sensors are connected to the electronic systems of the control panel of the apparatus.

It is clear from the above description that the handpiece pressed against the skin can be used to execute a plurality of functions simultaneously, including laser treatment, vacuum treatment and cooling. Thus, mechanical manipulation by means of the suction aperture or apertures, heat extraction by means of the cooled contact structure, and laser biostimulation by means of the emissions of the diodes located in the housings 24 can all be carried out simultaneously. Mechanical stimulation by means of rhythmic vacuum treatment is applied by pulsed suction through the passage 20 and the recess 18, allowing an area larger than the area of the passage 20 to be treated.

The wires for the electrical power supply to the laser diodes, the sensor wires, the pulsed suction line, and the outgoing and return tubes for the coolant fluid pass through the grip of the handpiece and through the flexible lead, if any, for connection to the apparatus.

To summarize, the apparatus according to the invention combines in a single machine a plurality of treatments, which can be applied simultaneously.

The handpiece can be used to provide massage, in which the direct mechanical action on the tissues produces a stimulating effect on the local blood circulation and on the lymphatic system, to improve skin trophism and oxygenate the cells. This mechanical massage is combined with the action of laser radiation of a semiconductor source using diodes. This type of radiation is commonly used in medicine; in particular, many lasers (including diode lasers) are used in physiotherapy for their “biostimulant” action on biological tissues. Laser biostimulation produces an anti-edemic effect by stimulating the lymphatic system and the venous microcirculation, thus promoting the elimination of toxins, bodily waste products and excess fluids retained as a result of fluid retention. A third action is that of cooling, in other words the extraction of heat from the tissues being treated.

The apparatus in question for the cure and reduction of cellulitis permits the combined and simultaneous application of three methods:

Laser biostimulation;

Heat removal by means of a cooled structure;

Mechanical massage manipulation by suction, in other words pulsed vacuum treatment.

The apparatus comprises a handpiece or in any case a treatment head (applicator) which can be used to combine on the patient's skin laser biostimulation, cooling and mechanical stimulation by rhythmic vacuum treatment produced by pulsed suction. The applicator can be held in the operator's hand or held in contact with the skin by means of a supporting arm connected to a stand; the arm can be provided with a movement device with sensors which switch on actuators to keep it in contact with the patient's skin.

Some of the required technical characteristics are as follows:

Frequency of pulsed suction: from 7 to 20 Hz

Maximum vacuum, Dp: 300-600 mbar

Temperature of coolant fluid: (15-25)° C.

Diode emission wavelength: 810 nm

Individual diode emission power: 1 W.

It is to be understood that the drawing shows only an example provided solely as a practical demonstration of the invention, and that this invention can be varied in its forms and arrangements without departure from the guiding principle of the invention.

1. Apparatus for the wide-ranging treatment of pathologies of the edematous fibrosclerotic panniculopathy (EFP) type, commonly called cellulite, including a device, designed to make contact with the skin, wherein said device comprises means for providing mechanical massage, means for extracting heat from the skin, and laser systems for biostimulation.

2. Apparatus according to claim 1, characterized by a pulsed suction unit connected to said device, said pulsed suction unit providing said mechanical massage.

3. Apparatus according to claim 2, characterized in that it comprises a handpiece or a treatment head including a skin contacting surface which includes an area for mechanical massage connected to said pulsed suction unit, an area for the extraction of heat, and an area comprising laser diodes.

4. Apparatus according to claim 3, characterized in that said handpiece or treatment head is provided with a recess in its skin contacting surface, said recess being connected to a passage for connection to said pulsed suction unit.

5. Apparatus according to claim 3, characterized in that the area for skin massage is positioned in the center of said skin contacting surface and is surrounded by an annular cooled area for the extraction of heat and by an area comprising laser diodes.

6. Apparatus according to claim 5, characterized in that the annular cooled area for the extraction of heat comprises a channel for the circulation of a coolant fluid.

7. Apparatus according to claim 5, characterized in that the annular area comprising laser diodes is outside the annular cooled area for the extraction of heat and comprises a plurality of laser diodes spaced apart from each other at essentially equal intervals.

8. Apparatus according to claim 3, characterized in that said skin contacting area of said handpiece or treatment head has an elliptical shape.

9. Apparatus according to claim 2 characterized in that said pulsed suction unit generates a pulsed suction with a frequency between 7 and 20 Hz.

10. Apparatus according to claim 9, characterized in that said pulsed suction unit generates a maximum vacuum between 300 and 600 mbar.

11. A handpiece for an apparatus for the treatment of pathologies of the edematous fibrosclerotic panniculopathy (EFP) type, commonly called cellulite, including a skin contacting surface, which includes an area for mechanical massage connectable to a pulsed suction unit for providing mechanical massage, an area for the extraction of heat, and an area comprising laser diodes for biostimulation.

12. Handpiece according to claim 11, characterized by a recess in its skin contacting surface, said recess being connected to a passage for connection to a pulsed suction unit.

13. Handpiece according to claim 11, characterized in that the area for skin massage is positioned in the center of said skin contacting surface and is surrounded by an annular cooled area for the extraction of heat and by an area comprising laser diodes.

14. Handpiece according to claim 13, characterized in that the annular cooled area for the extraction of heat comprises a channel for the circulation of a coolant fluid.

15. Handpiece according to claim 13, characterized in that the annular area comprising laser diodes is outside the annular cooled area for the extraction of heat and comprises a plurality of laser diodes spaced apart from each other at essentially equal intervals.

16. Handpiece according to claim 11 characterized in that said skin contacting area has an elliptical shape.

17. A method for treatment of pathologies of the edematous fibrosclerotic panniculopathy (EFP) type, commonly called cellulite, wherein: a device is applied on the skin of a person in need of said treatment, said device being designed to make contact with said skin and including means for providing mechanical massage, means for extracting heat from the skin, and laser systems for biostimulation; and wherein a combined treatment of mechanical massage, laser biostimulation and heat extraction is applied on tissues of said person in need of said treatment through said device.

18. Method according to claim 17, wherein said mechanical massage is generated by a pulsed suction applied through said device by a pulsed suction unit connected thereto.
